(19) United States
(12) Patent Application Publication
(10) Pub. No.: US 2005/0082210 A1
(43) Pub. Date: Apr. 21, 2005

(54) Device for intracorporeal and and extracorporeal purification

(76) Inventor: Olivier Claude Favre, Geneva (CH)

Correspondence Address: YOUNG & THOMPSON, 745 SOUTH 23RD STREET, 2ND FLOOR, ARLINGTON, VA, 22202, US

(21) Appl. No.: 10/496,669

(22) PCT Filed: Nov. 20, 2002
(86) PCT No.: PCT/IB02/04826

(30) Foreign Application Priority Data
Nov. 26, 2001 (EP) 01128017.9

(51) Int. Cl. B01D 61/32

(52) U.S. Cl. 210/109; 210/257.2; 210/143; 210/321.6; 210/646

(57) ABSTRACT

A device for intracorporeal and extracorporeal purification of patients suffering of renal failure, the purification being designed to clean up the patients' body by removing undesirable elements, in particular urea and water, the device for intracorporeal and extracorporeal purification allowing to combine the different known treatment methods, in particular peritoneal dialysis, hemofiltration, hemodialysis and ultrafiltration, the latter being performed by using preferably a peripheral vascular access.

The present invention relates to a device for the purification of patients suffering of renal failure, said purification being designed to clean up the patients' body by removing undesirable elements, in particular urea and water.

It may be realised by different known methods, the most basic ones being peritoneal dialysis, hemodialysis and hemofiltration. Peritoneal dialysis consists of filling the patient's peritoneum with a solution which is getting polluted by drifting of molecules through the natural membrane of the peritoneum and then is extracted by taking these molecules with it. Several cycles may be realised one after the other in order to increase the effectiveness of the method. The other methods consist of purifying the blood by circulating it outside the body at one side of an semi-permeable artificial membrane, certain components traversing this membrane under the effect, for hemodialysis, of a gradient of concentration or, for hemofiltration, of pressure. In certain cases the two methods are combined as for example in hemodiafiltration which simultaneously realises a hemodialysis and a hemofiltration. In any case the patient needs to be connected several times a week, typically three to six times, to the purification device for sessions taking several hours each.

Since the 1970s there are apparatuses allowing to realise these different purification methods. Most of them are only adapted for hemodialysis, others allow to realise either hemofiltration or hemodialysis or the combination of these two methods, hemodiafiltration. Apparatuses for peritoneal dialysis are usually simpler and limited to certain versions of this treatment.

Peritoneal dialysis is a method which applies in particular to patients wishing to be treated at home, which implies to the corresponding apparatuses a design guaranteeing the patient's security and simultaneously a simple manipulation. In its simplest version the management of the fluids is done manually by the patient himself. There are apparatuses which allow an automatic management of the fluids, thus reducing the work load on the patient and increasing the effectiveness of the treatment but extracting on the other hand important quantities of “large molecules” from the patient, in particular proteins, which is not desirable. Peritoneal dialysis moreover has the inconvenience to allow only to extract small quantities of water absorbed by the patient between two dialysis sessions. The effectiveness of peritoneal dialysis and of the corresponding apparatuses is limited by the capacity of the natural membrane of the peritoneum, therefore patients whose need of purification increases in time need to turn to another, more effective method and usually need to change the apparatus as well as the location of treatment, which represents an important inconvenience.

At the moment, the hemodialysis and hemofiltration sessions are realised essentially in clinical centres. Since the 1970s there are hemodialysis and hemofiltration apparatuses for use at home. In particular, one may cite the apparatuses of the firm AKSYS (USA) which have been specifically developed during the years 1995 to 2000 in order to cover the specific needs of hemodialysis and hemofiltration at home. The hemofiltration apparatuses of the firm GAMBRO have been used since the 1980s in order to realise hemofiltration at home.

In order to describe the state of the art in more detail, it has to be noted that peritoneal dialysis apparatuses generally have two pumps, the one in order to inject dialysis liquid, the dialysate, and the other in order to extract this liquid once it has been polluted. Means for managing the volumes entering and exiting from the patient allow to control the weight of the latter, i.e. allow to avoid an overload of the patient with dialysate and to control the volume of water extracted from him. In most of the cases sterile dialysate is injected out of bags. The adaptability of its discharge with the capacity of the patient's site is controlled with the help of pressure sensors situated on the injection and extraction conduits of the dialysate.

Hemodialysis apparatuses generally have three pumps, one to circulate the blood at the outside of the patient's body, one to circulate a liquid called dialysate or exchange solution in opposite direction with respect to the blood at the other side of the semi-permeable membrane, and one to control the volume of liquid extracted from the blood through said membrane, the regulating parameter usually being the pressure gradient throughout said membrane, commonly called transmembrane pressure. Generally, the dialysate is continuously produced by the hemodialysis apparatus using water and acid or salt powder. In some cases, the dialysate is directly injected out of bags. Measuring means for the discharge of dialysate and of extracted fluid are used to ensure the quality of the treatment and the control of the patient's weight. Means allowing to prevent the injection of air and to detect disconnection of the blood circuit or any other similar errors are foreseen, too.

Hemofiltration apparatuses generally comprise three or four pumps, one to circulate the blood at the outside of the patient, one to extract a polluted solution called ultrafiltrate through the membrane, and one or two to inject a substitution solution. If two pumps are used for the latter, one dilutes the blood before its contact with the semi-permeable membrane (predilution) and the other afterwards (postdilution). Measuring and control means of the volumes of ultrafiltrate and of substitution solution are completing these apparatuses. These are most often known scales or volume chambers associated to a control unit which, inter alia, watches that the patient's weight shall be mastered during the treatment. The substitution solution is injected out of bags, certain systems allowing however a continuous generation of substitution liquid from water and acids or salts. In these cases, passage through supplementary filters is required in order to render the solution sterile and apyrogenic before its injection into the patient.

If no substitution solution is injected, the treatment only consist of extracting the ultrafiltrate and is called ultrafiltration.

In a conventional apparatus for the extracorporeal purification of blood, the computation unit controlling the apparatus assures the circulation of blood and that of the volumes extracted and injected into the system as a function of functioning rules given for the treatment to be realised, of specifications from the operator, and of information read by different measuring means of the apparatus, in particular the effective circulation of blood. For example, if the discharge of blood is zero following an air or pressure alarm, the discharges of the exchange solution and of the polluted solution also have to be zero. In such an apparatus, the discharges of the exchange solution and of the polluted solution are controlled as a function of the effective circulation of blood. Therefore, if the polluted solution and the exchange solution were directly injected into the patient or extract from the patient like in case of the peritoneal dialysis in its basic mode, the computation unit couldn't deliver a non-zero discharge as the necessary criteria of the blood circulation weren't satisfied.

The apparatuses for the extracorporeal purification of blood are generally foreseen to extract blood from a site of the patient and to return it to another site. The blood circulation thus is continuous. In certain cases the apparatuses work in alternating extraction/re-injection mode with one single connection to the patient. One then adds expansion chambers on the blood circuit and a pump or supplementary clamps controlled by the computation unit on the apparatus. This supplementary complexity of the apparatus is sometimes preferred as it reduces the risk of infection of the patient by reducing the vascular connection sites by a factor 2. However, in peritoneal dialysis one always has a single site which is alternatively used to inject and to extract the dialysate.

In treatments acting on the blood the discharges of the polluted solution and of the exchange solution are continued as long as the blood pump works. However, in peritoneal dialysis the apparatus first injects the dialysate, waits until the dialysate gets polluted in the inside of the patient and then extracts the polluted solution. The cycles of polluted solution and of exchange solution therefore are alternated and separated by a stop period in peritoneal dialysis.

An apparatus functioning by extracorporeal circulation of blood moreover has security elements which are not incorporated in apparatuses for peritoneal dialysis. One may in particular cite the means allowing to avoid injection of air into the patient, often composed of air bubble traps, air detectors and clamps, and the means allowing to detect an eventual disconnection of blood circulation conduits, usually a pressure detector placed downstream the blood pump and another placed on the blood return line. If certain systems for peritoneal dialysis comprise means in order to avoid injection of air, disconnection of conduits isn't considered to be a major problem in this case because it doesn't imply any high risk for the patient. A disconnection however causes inconveniences for the hygiene of the patient, thus increasing the risk of infection of the site and soiling his environment, for example his bed. It therefore seems to be advisable to protect the patient against these two inconveniences.

Given what precedes, a conventional extracorporeal purification device adapted to purify the blood thus cannot be used in a peritoneal dialysis mode.

The interest of peritoneal dialysis is that it is particularly well adapted to the use by the patient himself at home due to the fact that it doesn't necessitate to extract the blood of the patient and thus avoids the corresponding risks like for example loss of blood by inadvertent opening of a conduit, gaseous embolism by injection of air or coagulation of blood in contact with the conduits and the semi-permeable membrane. Necessitating few material it moreover is economical.

Peritoneal dialysis comprises certain inconveniences, in particular the use of the peritoneum, a natural membrane, as semi-permeable membrane which limits the purification capacity of peritoneal dialysis which therefore isn't applicable to all patients. The renal capacities of a patient using this method may diminish in time constraining to the use of another method, usually hemodialysis. Peritoneal dialysis hence is in particular used at the beginning of renal failure when the kidneys still work partially thus delivering a complement of purification. A similar difficulty of peritoneal dialysis is that the capacity of extracting water from the patient is limited leading to a frequent hydrous overload of the patient and that it necessitates the addition of glucose in the dialysate which complicates its production and increases the cost of this latter. The quantities of lost proteins during each session are important and sometimes difficult to compensate. Moreover, the injection and extraction site in the patient's body gives occasion to relatively frequent infectious episodes. In this case the patient is. treaded by hemodialysis or hemofiltration in a clinical centre while waiting that the infection is reduced and that the site is again useable. The patient then often remains treated in the clinical centre as his renal failure may become more severe in the meantime, his infection may be such that it prevents to place a new site or the patient's confidence may be touched as severe that he wishes to renounce from treating himself.

These limits of peritoneal dialysis make that patients are treated in the mean only two or three years by this method before being purified by hemodialysis in a clinical centre. The investment relative to the training of the patient who has to learn to use his apparatus is then lost and his quality of life related to the flexibility of the hours and of the frequency of the treatment having been able to be realised at home decreases heavily. The patient often has to completely modify his management of time and has to reconsider his capacities to work.

Given the fact that patients normally start their treatment at home at a stage where the need of purification is relatively weak and therefore with an apparatus for peritoneal dialysis, the costs of changing apparatuses and the inconvenience of a re-training in order to be able to continue the treatment at home with more efficient treatment method, then the extracorporeal purification of blood, constitute non-negligible disadvantages.

The patents U.S. Pat. No. 4,190,047 and U.S. Pat. No. 4,338,190 describe apparatuses for peritoneal dialysis in which the dialysate in contact with the peritoneum is purified during the session through a semi-permeable membrane. Thus, like for a hemodialysis machine, one finds in the two inventions a first circulation loop for the dialysate and a second circulation loop in which it is here no more blood but also dialysate which is circulated and introduced into the patient's peritoneum.

The two loops are separated by said semi-permeable membrane in order to purify the dialysate being in the second loop in contact with the peritoneum, which allows to reduce the losses of proteins by recycling the dialysate.

The patent U.S. Pat. No. 5,141,493 describes a system of peritoneal dialysis also composed of two circulation loops for dialysate separated by a semi-permeable membrane but moreover equipped with a junction of the patient to the second loop controlled by an independent pump. The dialysate contained in the patient's body may thus be polluted independently of the cleaning of the dialysate which will be used during the next cycle.

If the mentioned inventions thus ameliorate peritoneal dialysis apparatuses by adding to them elements which can be found in hemodialysis apparatuses, they do no longer allow to realise peritoneal dialysis in its most economical and wide spread basic mode, i.e. without purification of the dialysate in a second circulation loop. In particular, the apparatuses are still constraint to peritoneal dialysis, the idea of using the second loop in another mode of operation, the extracorporeal circulation of blood, and thus of realising hemodialysis or hemofiltration on the one side and peritoneal dialysis on the other side with the same apparatus is not present. The mentioned inventions imply supplementary complexity concerning material and cost, in particular by the use of artificial filters, without solving the most severe problems of peritoneal dialysis, in particular the change of treatment method and apparatus necessary for example due to infection of the access sites to the peritoneal cavity of the patient.

Actually, none of the existing apparatuses for peritoneal dialysis allows to realise purification by extracorporeal circulation of blood like in hemodialysis or hemofiltration which would allow to avoid the inconveniences of peritoneal dialysis described above and would allow the patient to stay at home during an infection of the site or a decrease of his renal function. The complementary extracorporeal purification of blood would also allow to extract the overload of water of a patient treated by peritoneal dialysis by performing an ultrafiltation. With respect to the classical method of peritoneal dialysis, the use of a supplementary filter allows to purify the polluted solution in order to inject it again into the patient's body thus reducing the losses of proteins.

This more detailed description of the different known devices shows that the technical characteristics of the apparatuses vary for each type of treatment and that several versions exist. Certain apparatuses allow to realise several types of treatments and others to combine these types for example in order to realise hemodiafiltration with continuous generation of dialysate and of substitution liquid, other apparatuses injecting it out of bags. Nevertheless, no apparatus has been proposed to now which allows to realise peritoneal dialysis in its basic mode, on the one side, and purification by extracorporeal circulation of blood, on the other side, which is remarkable given the employment of all these treatment methods for decades.

It is an object of the present invention to remedy, at least partially, to the inconveniences mentioned above and to realise a device for intra- and extracorporeal purification of the patient allowing the combination of the different treatment methods known at the moment, in particular peritoneal dialysis, hemofiltration and hemodialysis, and offering moreover the possibility of applying ultrafiltration in order to relieve the hydrous overload of the patient without or with addition of glucose into the dialysate as well as means for the purification of the polluted solution in order to re-inject it into the body by avoiding important losses of proteins for the patient.

To this effect, the present invention concerns a device for intra- and extracorporeal purification comprising the characteristics spelled out in claim 1 and in the dependent claims.

The invention will be understood better with the help of the annexed figures which illustrate schematically and by way of example an embodiment of a device according to the present invention.

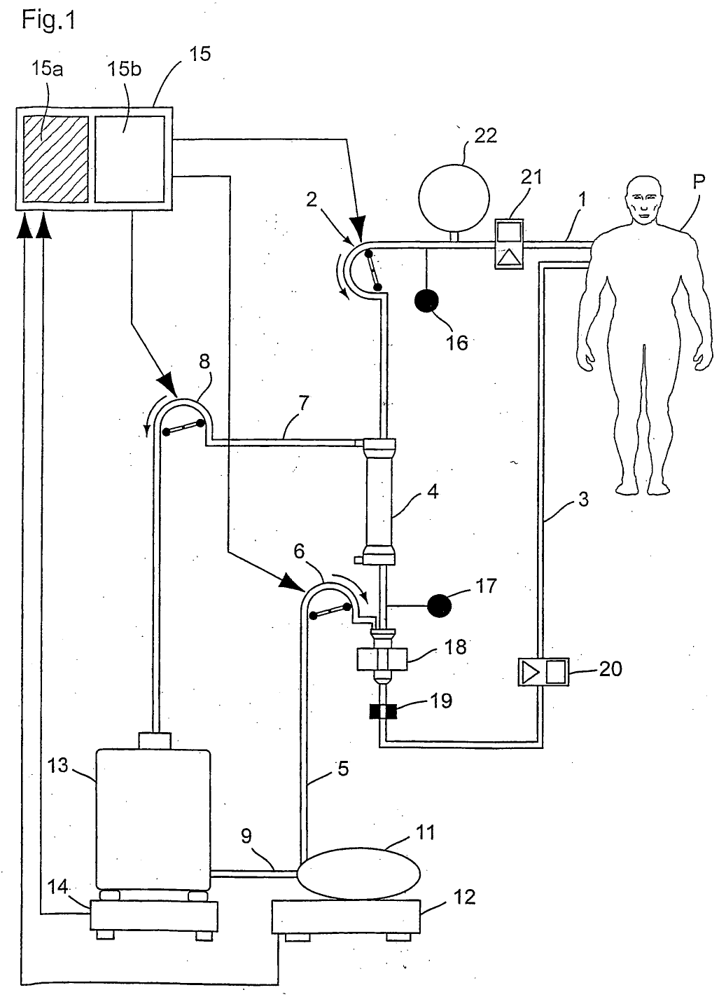

FIG. 1 schematically represents an embodiment of the invention allowing to realise a treatment based on the extracorporeal purification of blood like hemodialysis or hemofiltration.

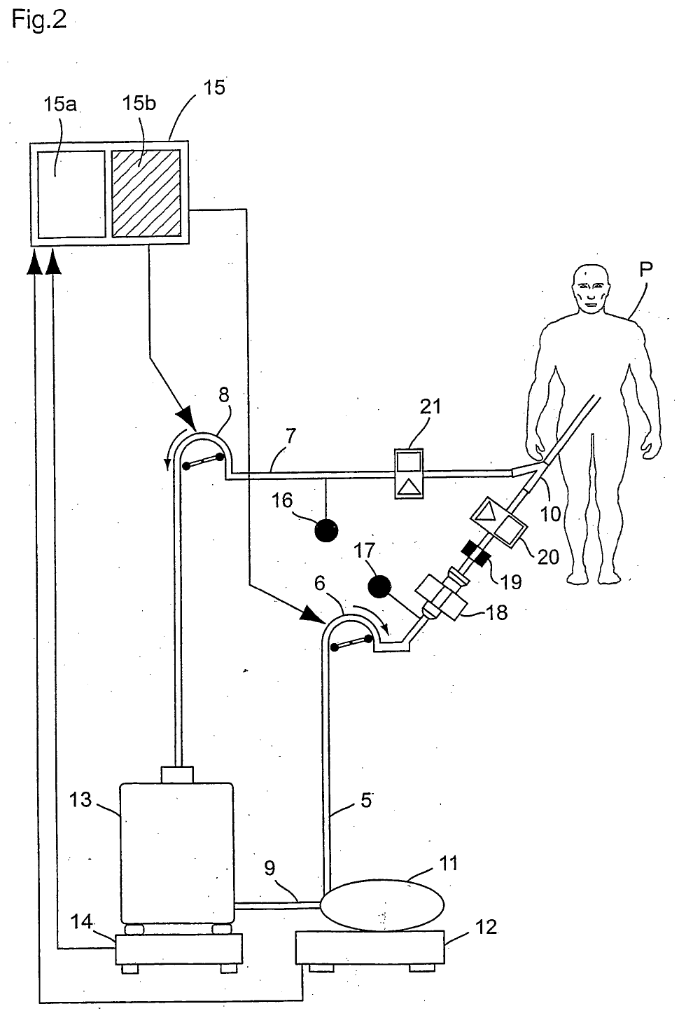

FIG. 2 illustrates an embodiment of the invention allowing to realise a treatment based on the use of the patient's peritoneal cavity like the peritoneal dialysis.

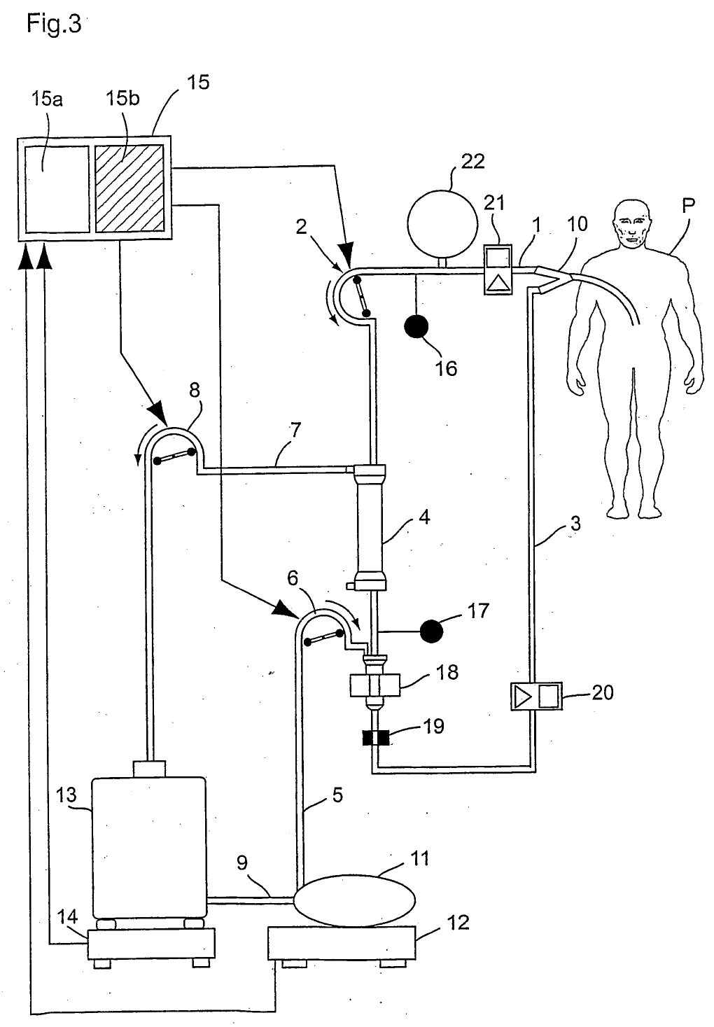

FIG. 3 schematically represents an embodiment of the invention allowing to realise a treatment based on the use of the patient's peritoneal cavity like the peritoneal dialysis allowing simultaneously to purify the polluted solution in order to re-inject it, with the large molecules and in particular the proteins, into the patient's body.

The following detailed description will explain with the help of the above mention figures the design, the functioning and the advantages of a device according to the present invention.

A purification device according to the present invention comprises, in order to allow a first operation mode of the device for the extracorporeal purification of blood, means for the extracorporeal circulation of blood, this extracorporeal circuit comprising an extraction conduit 1, discharge control means 2 like a pump to extract the blood from the body of the patient P, a return conduit 3 to return the purified blood into the patient's body and a purification element 4 which is situated between the extraction conduit 1 and the return conduit 3 and which has a semi-permeable membrane allowing to realise the purification of blood. A bubble trap 18 allows to retain air bubbles, an air detector 19 assures that air cannot be returned to the patient, a venous clamp 20 is closed in case of detection of air thus preventing the injection of air into the patient, and pressure detectors 16 and 17 allow to detect an eventual disconnection of the circuit for blood circulation. These elements are schematically illustrated in FIG. 1.

An admission conduit 5 for exchange solution having discharge control means 6, usually a pump or a clamp, connects a reservoir of exchange solution 11 to the circuit of extracorporeal circulation 1, 2, 3, 4. The reservoir of exchange solution 11 may be replaced by means of continuous generation of this solution out of water and acid or salt powder. The admission circuit 5 may be connected to the extraction conduit 1 (in predilution mode), to the return conduit 3 (in postdilution mode), to the purification element 4 at the side of the semi-permeable membrane where the blood doesn't circulate (in dialysis mode) or according to any combination of these different modes. The circuit of the exchange solution is completed by measuring means 12 of the mass of the exchange solution, for example force, volume or discharge detectors.

An evacuation conduit 7 of polluted solution having discharge control means 8, usually a pump or a clamp, is connected to the purification element 4 at the side of the semi-permeable membrane where the blood doesn't circulate. The polluted solution thus reaches evacuation means 13, said means being a unit of temporary collection, a bag or can, or a conduit allowing continuous evacuation. The evacuation circuit of the polluted solution is completed by measuring means 14 of the mass of the evacuated solution, for example force, volume or discharge detectors.

A control module 15 comprises computation means 15a which serve to steer the discharge control means 2, 6, 8 as a function of the parameters determining the respective quantities of blood, of exchange solution and of polluted solution. The indications delivered by the measuring means 12 and 14 are used by the computation means 15a to determine the masses entering into and exiting of the patient. Different steering methods exist and are described in the litterature. The parameters are generally commands given by the operator and values read by the detectors like for example the number of revolutions of the pumps, the masses measured by the scales or the number of cycles of filling/emptying of a testing tube of calibrated volume.

The usual components of extracorporeal purification devices which don't directly intervene in the field of the present invention aren't represented. These are in particular the blood leakage detector, detectors for transmembrane pressure, the blood or exchange liquid heater and the user interface.

The discharge control means 2, 6 and 8 are typically peristaltic pumps, roller pumps or clamps.

A purification device according to the present invention also allows, as schematically illustrated in FIG. 2 and in order to realise a second operation mode of the device for intracorporeal purification of the patient, i.e. peritoneal dialysis in its basic mode, on the one side to modify the fluid circulation tubing by taking off the circuit for extracorporeal circulation 1, 2, 3, 4 of blood and by adding a specific element 10 of Y-shape connected to the admission conduit 5 of the exchange solution, the evacuation conduit 7 and the patient's site, and on the other side to manage the fluid transport by one single site as well as by two sites by comprising, in addition to the first computation unit 15a, a second computation unit 15b adapted to steer the discharges of the exchange solution and of the polluted solution no more in simultaneous manner but in an alternative manner and independent of the circulation of blood. To that effect, the discharge control means 6 and 8 are steered as a function of a number of parameters defining the shape of the discharges as a function of time and the delay separating the injection cycle of the one of extraction and values read from the measuring means 12 and 14. The pressure detectors 16 and 17, here situated on the admission conduit 5 and the evacuation conduit 7, are used in this case with respect to two aims. On the one side in order verify that the site allows to assure the desired discharges and on the other side in order to detect an eventual disconnection of the circuits. In a variant, one single detector preferentially situated on the specific element 10 may deliver the same indications.

A purification device according to the present invention allows in still another operation mode in order to realise a more elaborated peritoneal dialysis, which is illustrated in FIG. 3, to circulate instead of blood the exchange solution in the extracorporeal circuit, which is thus injected into the patient's peritoneum, then extracted and afterwards purified with the help of the purification means 4 such as to retain the solutes of large dimensions the depletion of which harms the patient's state of health in the usual employment of peritoneal dialysis where the polluted dialysate is entirely evacuated. The device comprises to this effect two clamps 20, 21 and an expansion chamber 22 allowing to circulate the dialysate in alternating mode by using a unique site. The specific element 10 or a unique needle can be integrated into the tubing serving usually as extracorporeal blood circuit 1, 2, 3, 4 which therefore may be connected in this operation mode to a unique site of the patient's peritoneum. In this case, one initially injects exchange solution into the peritoneum by opening clamp 20, closing clamp 21 and letting work the discharge control means 6. The exchange solution may then for a predetermined period extract undesired elements through the membrane of the peritoneum out of the patient's body. To extract the polluted dialysate, clamp 20 is closed and clamp 21 opened while the discharge control means 2 are activated, which fills the expansion chamber 22. To return the dialysate to the patient, one opens clamp 20 and closes again clamp 21 and activates discharge control means 2 thus emptying chamber 22. During this return phase, pumps 6, 8 are activated in order to purify the polluted dialysate which passes into the purification element 4. The pressure detectors 16, 17 allow to detect the end of the extraction or return cycles. The second computation unit 15b is configured such as to be able to manage this operation mode by steering the discharge control means 2, 6, 8 taking into account the detected values of the pressure detectors 16, 17. Recycling of the exchange solution is thus possible and important losses of proteins may be avoided by this device.

The same device with a tubing as described above but the extracorporeal circuit 1, 2, 3, 4 being connected, for example with the help of a unique needle, to the patient's blood circuit may be used for extracorporeal purification of blood by using the elements like the clamps 20, 21 and the expansion chamber 22 in an adequate manner for this operation mode. The invention thus also applies to systems comprising extracorporeal blood circulation elements having a unique needle and to its different versions described in literature.

An embodiment of a purification device according to the present invention allows to realise a treatment of the ultrafiltration type by extracting water out of the patient's blood. In the preferred mode, the device extracts blood from an unique peripheral vascular access site. Like described above, the tubing allows the use of a unique needle, and the parameters of the computation unit 15a are in this case adapted in order to allow blood circulation at a discharge lower than the one used with vascular access sites obtained by catheters or fistulas.

A device according to the invention hence is adapted to effectuate peritoneal dialysis as well as hemodialysis or hemofiltration and ultrafiltration in different treatment variants, thus realising an intra- and extracorporeal purification of blood.

In all the cases described above, the reservoir of the exchange solution 11 and the evacuation means 13 may be connected by a connection conduit 9 or formed by one single component with the aim to use the evacuated solution as exchange solution. Actually, as it is rare that the exchange solutions will be saturated after the first passage in the purification element 4, this method allows to economise fresh exchange solution.

Also, the invention applies to apparatuses integrating or not integrating the production of exchange solutions , as well as to combined methods like hemodiafiltration or the simultaneous use of predilution and postdilution.

A device according to the invention may also comprise means for cleaning the purification element 4 and the tubing. These elements are then stored on the apparatus and used for several consecutive treatments. The cleaning means allow the injection of a cleaning substance, for example acetic acid, and of a rinsing substance, for example a saline solution, and moreover comprise control and security means, for example a probe measuring the pH-value of the liquid contained in the circuit of extracorporeal circulation.

It is evident that the idea of the present invention embraces the possibility to realise a device for intra- and extracorporeal purification according to the invention by adding pieces of tubing, of steering, of control and of security as well as computation means necessary to that effect to an apparatus for peritoneal dialysis in order to realise with such an apparatus also purification of blood by hemodialysis, by hemofiltration and/or by ultrafiltration.

This is possible for all embodiments described above, without the need to repeat the details and without any limitation of the employment of the invention to that effect.

It is also possible to deliver the pieces and/or the necessary control means to realise a device for intra- and extracorporeal purification according to the invention starting with an apparatus for extracorporeal purification of blood hence allowing to this latter to also carry out peritoneal dialysis without or with recycling of the exchange solution.

A device for purification of the body according to the present invention thus allows to perform the different methods of extracorporeal purification described above, namely on the one side peritoneal dialysis and on the other side the complementary methods which are hemodialysis, hemofiltration and ultrafiltration as well as the combination of these methods by comprising circuits adapted to each of these treatment methods and by also comprising the corresponding fluid control and management means.

The invention therefore allows to avoid hydrous overload of the patient in peritoneal dialysis with or without addition of glucose into the dialysate.

Moreover, the annoying losses of proteins may be avoided by recycling the exchange solution like described above by using such a device.

An additional advantage of the invention resides in the fact that it allows to the patient initially using peritoneal dialysis to maintain his achievements (formation, quality of life) even if his renal capacities diminish or if his injection/extraction site in no longer useable.

1. Device for intra- and extracorporeal purification comprising a reservoir for exchange solution (11), an admission conduit (5) for exchange solution connected at one end to this reservoir (11) and discharge control means (6) in order to manage the circulation of the exchange solution in the admission conduit (5) as well as an evacuation conduit (7) of polluted solution, evacuation means (13) for the polluted solution situated at one end of the evacuation conduit (7) and discharge control means (8) in order to manage the circulation of the polluted solution in said evacuation conduit (7), characterised by the fact that the reservoir for exchange solution (11) and the evacuation means (13) of the polluted solution are connected either directly to a site of the patient (P) with the help of a specific element (10) in order to perform peritoneal dialysis or to a circuit for extracorporeal circulation (1,2,3,4) which is itself connected to the patient in order to perform extracorporeal blood purification, and by the fact that a control module (15) comprises computation means (15b) which control the discharge control means (6) of the exchange solution and the discharge control means (8) of the polluted solution in order to allow for an operation mode of the device for peritoneal dialysis and computation means (15a) which control the discharge control means (6) of the exchange solution, the discharge control means (8) of the polluted solution and the circulation in the extracorporeal circuit (1,2,3,4) in order to allow for an operation mode of the device for extracorporeal purification of blood.

2. Device for intra- and-extracorporeal purification according to claim 1, characterised by the fact that the circuit for extracorporeal circulation is composed of an extraction conduit (1), a return conduit (3), purification means (4) situated between the extraction conduit (1) and the return conduit (3) and discharge control means (2) to maintain the circulation in this circuit.

3. Device for intra- and extracorporeal purification according to claim 1, characterised by the fact that the circuit for extracorporeal circulation (1,2,3,4) further comprises said specific element (10) or an element with a unique needle which comprise at least three connecting pieces and allow to connect said circuit to a unique site of the patient as well as to the free ends either of the admission conduit (5) and of the evacuation conduit (7) or of the circuit for extracorporeal circulation (1,2,3,4), this circuit being generally adapted to transport blood and exchange solution into and out of the body by a unique site as well as by two separated sites of the patient.

4. Device for intra- and extracorporeal purification according to claim 1, characterised by the fact that it comprises control means (20, 21) situated on the conduits (1, 3) of the circuit for extracorporeal circulation and adapted to assure the injection/return and extraction cycles either of blood or of exchange solution as well as an expansion chamber (22) situated on the extraction conduit (1) of the circuit for extracorporeal circulation which may be filled during the extraction cycle and emptied during the return cycle.

5. Device for extracorporeal purification according to claim 3, characterised by the fact that the computation means (15a) are adapted to control the blood circulation in the extracorporeal circuit (1,2,3,4) at a lower discharge with respect to the one used with vascular access sites obtained by catheters or fistulas in order to realise a treatment of the ultrafiltration type by extracting blood from a unique peripheral vascular access site and by then extracting water through purification means (4) out of the patient's blood.

6. Device for intra- and extracorporeal purification according to claim 1, characterised by the fact that the reservoir for exchange solution (11) is connected to the evacuation means (13) of the polluted solution with the help of a connection conduit (9) in order to allow for re-circulation of the polluted solution.

7. Device for intra- and extracorporeal purification according to claim 1, characterised by the fact that the reservoir for exchange solution (11) and the evacuation means (13) of the polluted solution are formed by a single component in order to allow for re-circulation of the polluted solution.

8. Device for intra- and extracorporeal purification according to claim 1, characterised by the fact that it comprises means for continuous production of exchange solution.

9. Device for intra- and extracorporeal purification according to claim 1, characterised by the fact that it comprises means for cleaning the purification means (4) as well as the tubing, these cleaning means allowing the injection of a cleaning substance and of a rinsing substance and further comprising control and security means.

10. Device for purification, characterised by the fact that it comprises on the one side a circuit for extracorporeal circulation (1,2,3,4,10) comprising corresponding steering, control and security means, this circuit being generally adapted to transport blood or exchange solution into and out of the body by a unique site or by two separated sites of the patient, and/or on the other side computation means (15a) adapted to control the discharge control means (6) of the exchange solution, the discharge control means (8) of the polluted solution and the circulation in the extracorporeal circuit (1,2,3,4), these elements being adapted to co-operate with an existing device for purification by peritoneal dialysis and allowing this latter to carry out the different treatment methods, in particular an operation mode of the existing device for extracorporeal purificationn of blood by hemodialysis, hemofiltration and/or ultrafiltration.

11. Device for intra- and extracorporeal purification according to claim 2, characterised by the fact that the circuit for extracorporeal circulation (1,2,3,4) further comprises said specific element (10) or an element with a unique needle which comprise at least three connecting pieces and allow to connect said circuit to a unique site of the patient as well as to the free ends either of the admission conduit (5) and of the evacuation conduit (7) or of the circuit for extracorporeal circulation (1,2,3,4), this circuit being generally adapted to transport blood and exchange solution into and out of the body by a unique site as well as by two separated sites of the patient.

12. Device for extracorporeal purification according to claim 4, characterised by the fact that the computation means (15a) are adapted to control the blood circulation in the extracorporeal circuit (1,2,3,4) at a lower discharge with respect to the one used with vascular access sites obtained by catheters or fistulas in order to realise a treatment of the ultrafiltration type by extracting blood from a unique peripheral vascular access site and by then extracting water through purification means (4) out of the patient's blood.
